(19) United States
(12) Patent Application Publication
(10) Pub. No.: US 2015/0177856 A1
(43) Pub. Date: Jun. 25, 2015

(54) DIGITAL PEN SYSTEM AND PEN BASED INPUT METHOD

(71) Applicant: NEC Corporation, Tokyo (JP)

(72) Inventors: Hiroshi KAJITANI, Tokyo (JP); Junichi Miyamoto, Tokyo (JP)

(21) Appl. No.: 14/641,116

(22) Filed: Mar. 6, 2015

Related U.S. Application Data
(63) Continuation of application No. 13/500,289, filed on Apr. 4, 2012.

(30) Foreign Application Priority Data
Oct. 7, 2009 (JP) 2009-233894

(51) Int. Cl. G06F 3/0346; G06F 3/038; G06F 3/03

(52) U.S. Cl. CPC G06F 3/0346; G06F 3/0304; G06F 3/0383; G06F 3/0386

(57) ABSTRACT

A digital pen system includes a rod-shaped digital pen that periodically transmits a signal including information about a direction of the digital pen, and a receiving apparatus that detects a position and the direction of the digital pen in three-dimensional space based on the signal, calculates an intersection of an extension line of the digital pen in a longitudinal direction thereof and a display screen of a display apparatus in a case that the digital pen and the display screen are apart from each other, and enables the display apparatus to perform a pen-based input at the intersection on the display screen.

The present application is a Continuation application of U.S. patent application Ser. No. 13/500,289, filed on Apr. 4, 2012, which is based on International Application No. PCT/JP2010/067639, filed on Oct. 7, 2010, which is based on Japanese patent application No. 2009-233894, filed on Oct. 7, 2009, the entire contents of which are incorporated herein by reference.

The present invention relates to a digital pen system and a pen-based input method. In particular, it relates to a digital pen system and a pen-based input method that enable input to a display apparatus based on a pen operation in three-dimensional free space.

### BACKGROUND

Patent Document 1 discloses an electronic pen (digital pen) system based on a position detection method using an ultrasonic wave. This digital pen system includes: a digital pen transmitting an ultrasonic wave signal and an infrared trigger signal which have a fixed waveform in a fixed cycle; and a reception unit receiving the two signals transmitted. The reception unit determines the location of the electronic pen based on a trigger signal arrival time and an ultrasonic wave arrival time.

Patent Document 2 discloses a wireless pen (digital pen) system that enables two-dimensional pen-based input on a display panel based on an ultrasonic wave signal and an infrared-ray signal.

Patent Document 3 discloses a distance detection apparatus capable of improving the SN (signal to noise) ratio of a received signal.

Patent Document 4 discloses a distance measurement apparatus that measures the propagation time of an ultrasonic wave to measure a distance.
Patent Document 1: U.S. Pat. No. 6,118,205
Patent Document 2: Japanese Patent Kokai Publication No. JP2004-192142A
Patent Document 3: Japanese Patent Kokai Publication No. JP2005-249770A
Patent Document 4: Japanese Patent Kokai Publication No. JP-H08-184671A
Non-Patent Document 1: Hiroshi Kashiwagi, “M-sequence and Its Applications,” Shokodo, 1996

### SUMMARY

The entire disclosures of the above Patent Documents 1 to 4 and Non-Patent Document 1 are incorporated herein by reference thereto. The following analyses are given by the present invention.

The digital pen system according to Patent Document 1 can detect the location of the electronic pen in three-dimensional space. However, in the digital pen system, since the direction of the digital pen is unclear, pen-based input at the intersection of a display screen provided away from the digital pen and the direction in which the digital pen points cannot be carried out.

Thus, there is a need in the art to provide a digital pen system and a pen-based input method that enables pen-based input at the intersection of a display screen provided away from the digital pen and the direction in which the digital pen points.

According to a first aspect of the present invention, there is provided a digital pen system comprising:

a rod-shaped digital pen that periodically transmits a signal including information about a direction of the digital pen; and
a receiving apparatus that detects a position and direction of the digital pen in three-dimensional space based on the signal, calculates an intersection of an extension line of the digital pen in a longitudinal direction thereof and a display screen of a display apparatus, and enables the display apparatus to perform pen-based input at the intersection.

According to a second aspect of the present invention, there is provided a pen-based input method comprising:

by a digital pen, periodically transmitting a signal including information about a direction of the digital pen; and
by a receiving apparatus, detecting a position and direction of the digital pen in three-dimensional space based on the signal, calculating an intersection of an extension line of the digital pen in a longitudinal direction thereof and a display screen of a display apparatus, and enabling the display apparatus to perform pen-based input at the intersection.

The present invention provides the following exemplary advantage, but not restricted thereto. A digital pen system and a pen-based input method according to the present invention enable pen-based input at the intersection of a display screen provided away from a digital pen and the direction in which the digital pen points.

### BRIEF DESCRIPTION OF THE DRAWINGS

FIG. 1 schematically illustrates a configuration of a digital pen system according to a first exemplary embodiment.

FIG. 2 is a block diagram illustrating a configuration of the digital pen system according to the first exemplary embodiment.

FIG. 3 is a block diagram illustrating a configuration of a digital pen system according to a second exemplary embodiment.

FIG. 4 illustrates a waveform of an ultrasonic wave driving signal whose phase has been modulated by M-sequence data.

FIG. 5 schematically illustrates a configuration of a digital pen system according to a third exemplary embodiment.

FIG. 6 schematically illustrates a configuration of a digital pen system according to a fourth exemplary embodiment.

### EXEMPLARY MODES

In the present disclosure, there are various possible exemplary modes, which include the following, but not restricted thereto.

It is preferable that a digital pen system according to a first applicable mode be a digital pen system according to the above first aspect.

In a digital pen system according to a second applicable mode, it is preferable that the digital pen further comprise at least one angle sensor that determines at least four-axis directions and that the direction of the digital pen be determined based on the angle sensor.

In a digital pen system according to a third applicable mode, it is preferable that the angle sensor comprise an acceleration sensor.

In a digital pen system according to a fourth applicable mode, it is preferable that the angle sensor comprise a three-axis acceleration sensor and a two-axis acceleration sensor.

In a digital pen system according to a fifth applicable mode, it is preferable that the angle sensor comprise a gyro sensor.

In a digital pen system according to a sixth applicable mode, it is preferable that the digital pen further comprise:

an electromagnetic wave transmitting unit that transmits an electromagnetic wave signal representing a transmission timing;
an ultrasonic wave driving unit that modulates an ultrasonic wave based on a pseudorandom signal having high autocorrelation simultaneously with transmission of the electromagnetic wave signal to generate an ultrasonic wave driving signal; and
an ultrasonic wave transmitting unit that is driven by the ultrasonic wave driving signal and transmits an ultrasonic wave signal having a frequency higher than a fundamental frequency of the ultrasonic wave driving signal.

In addition, it is preferable that the receiving apparatus further comprise:

an electromagnetic wave receiving unit that detects the electromagnetic wave signal;
an ultrasonic wave receiving unit that comprises at least three ultrasonic wave detecting units that are not arranged on a single line and receives the ultrasonic wave signal via the ultrasonic wave detecting units; and
a propagation time calculating unit that uses a waveform identical to that of the ultrasonic wave driving signal as a model waveform, calculates correlation values between the received ultrasonic wave signal and the model waveform, detects a main peak value of the calculated correlation values, and calculates an ultrasonic wave propagation time based on the time when the electromagnetic wave signal is detected and the time when the main peak value is detected.

In a digital pen system according to a seventh applicable mode, it is preferable that the ultrasonic wave transmitting unit comprise a piezoelectric element or a magnetostrictive element.

In a digital pen system according to an eighth applicable mode, it is preferable that the ultrasonic wave transmitting unit have a transmission surface that is substantially (approximately) spherical.

In a digital pen system according to a ninth applicable mode, it is preferable that the ultrasonic wave receiving unit comprise a piezoelectric element, a magnetostrictive element, or a microphone.

In a digital pen system according to a tenth applicable mode, it is preferable that at least two of the at least three ultrasonic wave detecting units be fixedly positioned.

In a digital pen system according to an eleventh applicable mode, it is preferable that the at least three ultrasonic wave detecting units be provided on the display screen or on an extension surface thereof.

In a digital pen system according to a twelfth applicable mode, it is preferable that the digital pen comprise a laser pointer that indicates the intersection.

In a digital pen system according to a thirteenth applicable mode, it is preferable that generation timings of the laser pointer and the ultrasonic wave signal and/or the electromagnetic wave signal be coordinated and that the track (or tracking) of the laser pointer be displayed on the display screen.

In a digital pen system according to a fourteenth applicable mode, it is preferable that the pseudorandom signal be an M-sequence signal.

It is preferable that a pen-based input method according to a fifteenth applicable mode be the pen-based input method according to the above second aspect.

It is preferable that a pen-based input method according to a sixteenth applicable mode comprise:

by the digital pen, transmitting an electromagnetic wave signal representing a transmission timing;
modulating an ultrasonic wave based on a pseudorandom signal having high autocorrelation simultaneously with transmission of the electromagnetic wave signal to generate an ultrasonic wave driving signal; and
being driven by the ultrasonic wave driving signal and transmitting an ultrasonic wave signal having a frequency higher than a fundamental frequency of the ultrasonic wave driving signal.

It is preferable that a pen-based input method according to a seventeenth applicable mode comprise:

by the receiving apparatus, detecting the electromagnetic wave signal; receiving the ultrasonic wave signal via at least three ultrasonic wave detecting units that are not arranged on a single line; and
using a waveform identical to that of the ultrasonic wave driving signal as a model waveform, calculating correlation values between the received ultrasonic wave signal and the model waveform, detecting a main peak value of the calculated correlation values, and calculating an ultrasonic wave propagation time based on the time when the electromagnetic wave signal is detected and the time when the main peak value is detected.

### First Exemplary Embodiment

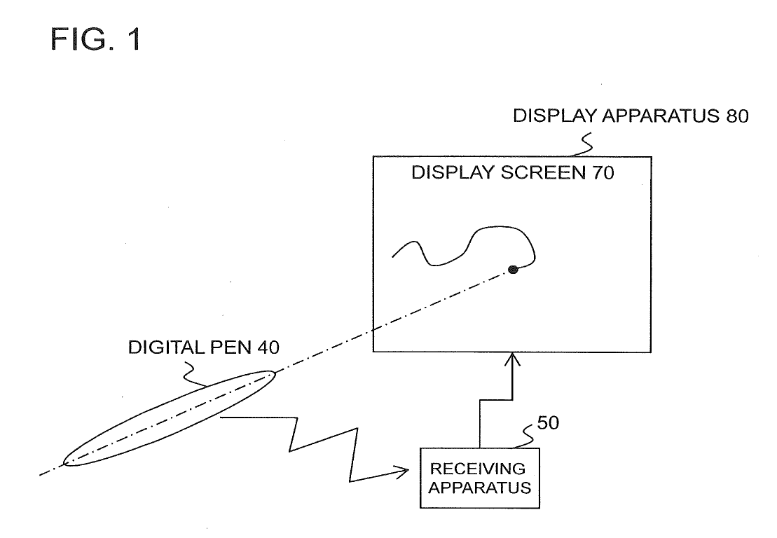

A digital pen system according to a first exemplary will be described with reference to the drawings. FIG. 1 schematically illustrates a configuration of a digital pen system according to the present exemplary embodiment. In FIG. 1, the digital pen system includes a digital pen 40 and a receiving apparatus 50. The digital pen system enables input on a display screen 70 of a display apparatus 80.

The digital pen 40 is a rod-shaped (pen-shaped) object that periodically transmits a signal including information about the direction of the digital pen 40. The receiving apparatus 50 detects the position and direction of the digital pen 40 in three-dimensional space based on the signal and calculates the intersection of an extension line of the digital pen 40 in a longitudinal direction thereof and the predetermined display screen 70, to perform drawing at the intersection.

It is preferable that the digital pen 40 further include an angle sensor (not illustrated) determining at least four-axis directions and that the direction of the digital pen 40 be determined based on the angle sensor. In addition, it is preferable that the angle sensor include an acceleration sensor. For example, the angle sensor may include a three-axis acceleration sensor and a two-axis acceleration sensor. In addition, the angle sensor may include a gyro sensor.

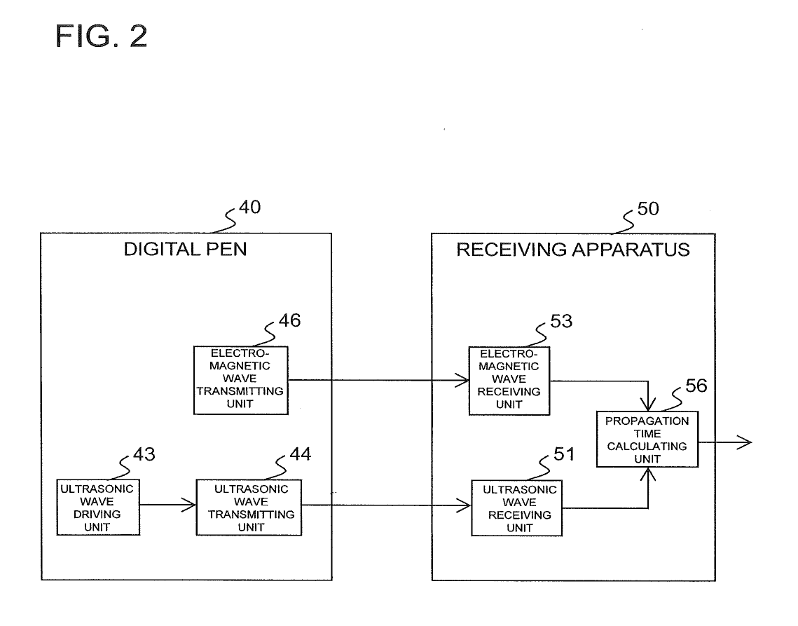

FIG. 2 is a block diagram illustrating a configuration of the digital pen system according to the present exemplary embodiment. In FIG. 2, the digital pen 40 includes an electromagnetic wave transmitting unit 46, an ultrasonic wave driving unit 43, and an ultrasonic wave transmitting unit 44. The receiving apparatus 50 includes an electromagnetic wave receiving unit 53, an ultrasonic wave receiving unit 51, and a propagation time calculating unit 56.

The electromagnetic wave transmitting unit 46 transmits an electromagnetic wave signal representing a transmission timing. The ultrasonic wave driving unit 43 modulates an ultrasonic wave based on a pseudorandom signal having high autocorrelation and generates an ultrasonic wave driving signal, simultaneously with transmission of the electromagnetic wave signal. The ultrasonic wave transmitting unit 44 is driven by the ultrasonic wave driving signal and transmits an ultrasonic wave signal having a frequency higher than a fundamental frequency of the ultrasonic wave driving signal.

The electromagnetic wave receiving unit 53 detects the above electromagnetic wave signal. The ultrasonic wave receiving unit 51 includes at least three ultrasonic wave detecting units (not illustrated) that are not arranged on a single line and receives the above ultrasonic wave signal via the ultrasonic wave detecting units. The propagation time calculating unit 56 uses a waveform identical to that of the above ultrasonic wave driving signal as a model waveform, calculates correlation values between the ultrasonic wave signal and the model waveform, and detects a main peak value of the calculated correlation values, to calculate an ultrasonic wave propagation time based on a time at which the above electromagnetic wave signal is detected and a time at which the main peak value is detected.

The receiving apparatus 50 can determine the three-dimensional position and direction of the digital pen 40, based on the electromagnetic wave signal and the ultrasonic wave signal transmitted from the digital pen 40. Thus, based on the digital pen system according to the present exemplary embodiment, drawing can be performed at a point indicated by the pen on the display screen 70 provided away from the pen.

It is preferable that the digital pen 40 include a laser pointer indicating the intersection of the extension line of the digital pen 40 in a longitudinal direction thereof and the display screen 70. In this way, users of the digital pen system can easily execute an input operation.

### Second Exemplary Embodiment

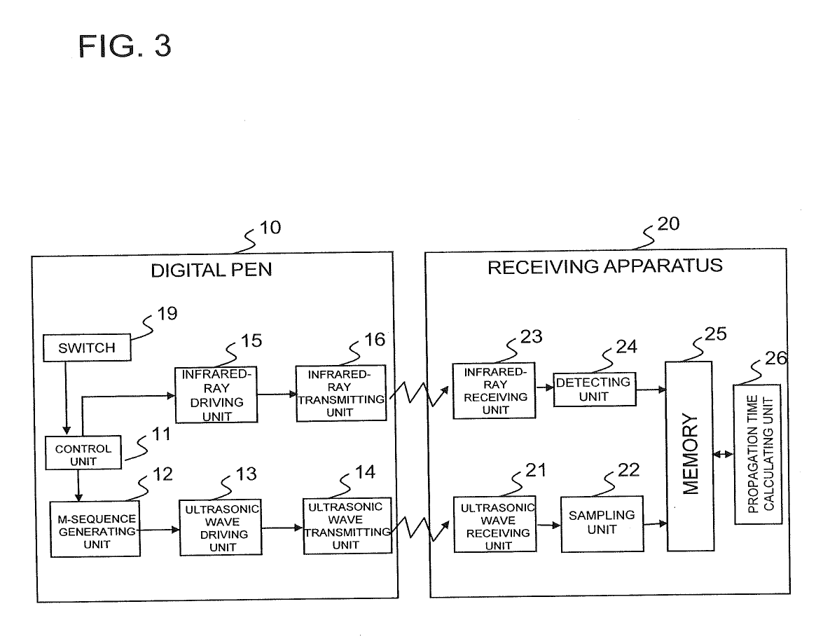

A digital pen system according to a second exemplary embodiment will be described with reference to the drawings. FIG. 3 is a block diagram illustrating a configuration of a digital pen system according to the present exemplary embodiment.

In FIG. 3, the digital pen system includes a digital pen 10 and a receiving apparatus 20. The receiving apparatus 20 is installed at a predetermined position away from the digital pen 10.

The digital pen 10 includes a switch 19, a control unit 11, an M-sequence generating unit 12, an ultrasonic wave driving unit 13, an ultrasonic wave transmitting unit 14, an infrared-ray driving unit 15, and an infrared-ray transmitting unit 16.

The M-sequence generating unit 12 generates M-sequences, based on M-sequence initial conditions supplied from the control unit 11 and a characteristic polynomial. For example, the M-sequence generating unit 12 includes a 4-bit shift resistor having characteristics of a quartic characteristic polynomial f(x)=x⁴+x+1 or f(x)=x⁴+x³+1 and generates a bit string having a sequence length of 15 bits. By changing 4-bit initial conditions, 15 kinds of different data, each of which has data arrangement shifted cyclically, can be obtained. The M-sequence generating unit 12 may refer to a memory storing M-sequence bit strings to generate an M-sequence.

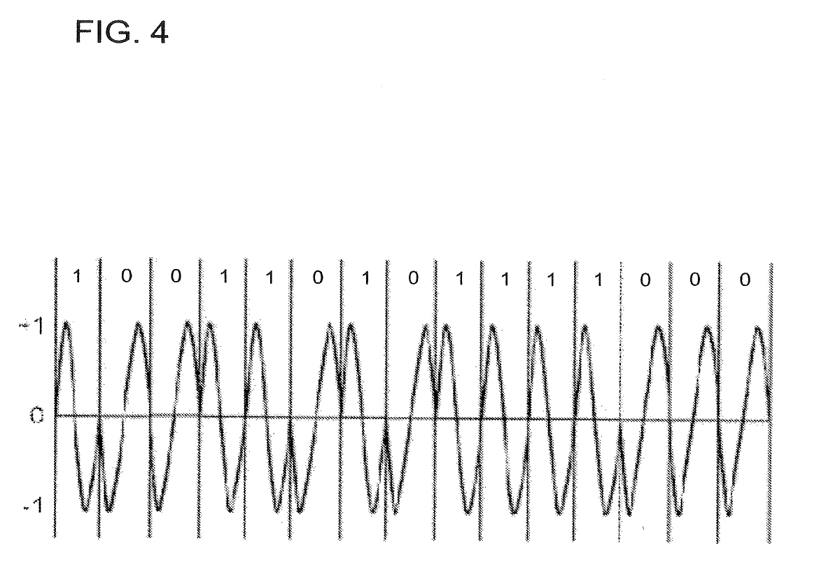

FIG. 4 illustrates a waveform of an ultrasonic wave driving signal whose phase has been modulated by an M-sequence. In FIG. 4, each bit of the 15-bit M-sequence data “100110101111000” corresponds to one cycle of a fundamental wave. An inverted phase is used for zero, and a forward phase is used for one. The modulated wave has a length of 15 cycles of the fundamental wave. M-sequences are described in detail in Non-Patent Document 1, which is incorporated herein in its entirety.

In the above description, an M-sequence signal, which is a pseudorandom signal having high autocorrelation, is used to modulate the phase of the ultrasonic wave. However, use of another modulation technique can provide a similar effect. In addition, an arbitrary signal sequence may be used for modulation, as long as the signal sequence is a pseudorandom signal having high autocorrelation. For example, use of a Gold sequence signal can provide a similar effect.

When a user presses the switch 19 of the digital pen 10, first, the control unit 11 transmits a trigger signal used as a reference for time measurement and 4-bit initial conditions for an M-sequence to the infrared-ray driving unit 15 and the M-sequence generating unit 12.

The infrared-ray driving unit 15 generates an infrared driving signal, based on the signals from the control unit 11.

The infrared-ray transmitting unit 16 is driven by the infrared driving signal and transmits an infrared-ray signal from the digital pen 10.

The M-sequence generating unit 12 generates an M-sequence bit string, based on the initial conditions supplied from the control unit 11. The M-sequence generating unit 12 supplies the M-sequence bit string to the ultrasonic wave driving unit 13.

The ultrasonic wave driving unit 13 modulates the phase of an ultrasonic wave signal, based on the supplied M-sequence. The ultrasonic wave driving unit 13 supplies the modulated ultrasonic wave signal to the ultrasonic wave transmitting unit 14, as an ultrasonic wave driving signal.

The ultrasonic wave transmitting unit 14 is driven by the ultrasonic wave driving signal and transmits the ultrasonic wave signal whose phase has been modulated based on the M-sequence, in synchronization with a transmission timing of the infrared-ray transmitting unit 16. The ultrasonic wave transmitting unit 14 may include a piezoelectric element or a magnetostrictive element, for example.

The infrared-ray signal and the ultrasonic wave signal are simultaneously transmitted from the digital pen 10 to the receiving apparatus 20. The digital pen system repeats the above operation in a fixed cycle while the switch 19 is being pressed.

If the control unit 11 is configured by a CPU (Central Processing Unit), a rectangular wave is used as each of the signal waveforms. It is preferable that the infrared trigger signal used as a reference for time measurement be a rectangular wave. In this way, since a time error in sampling executed by the receiving apparatus 20 can be reduced, a measuring error can be minimized. If the ultrasonic wave transmitting unit 14 is configured by using a piezoelectric element or a magnetostrictive element, the piezoelectric element itself includes L and C components. Thus, even if the driving waveform is a rectangular wave, the ultrasonic wave signal exhibits a pseudo sine wave. The waveforms to be transmitted may be sine waves, rectangular waves, triangular waves, or trapezoidal waves, in view of characteristics of the digital pen 10.

The receiving apparatus 20 includes an ultrasonic wave receiving unit 21, a sampling unit 22, an infrared-ray receiving unit 23, a detecting unit 24, a memory 25, and a propagation time calculating unit 26. The propagation time calculating unit 26 includes an ultrasonic sound pressure measurement block and an ultrasonic frequency measurement block (not illustrated).

The ultrasonic wave receiving unit 21 receives the ultrasonic wave signal from the digital pen 10 and converts the ultrasonic wave signal into an electrical signal. The ultrasonic wave receiving unit 21 may include a piezoelectric element, a magnetostrictive element, or a microphone, for example.

The sampling unit 22 samples the ultrasonic wave signal at regular intervals and stores the signal in the memory 25 as phase-modulated M-sequence ultrasonic data.

The infrared-ray receiving unit 23 receives the infrared-ray signal from the digital pen 10 and converts the infrared-ray signal into an electrical signal.

When the detecting unit 24 detects a trigger pulse from the output from the infrared-ray receiving unit 23, the detecting unit 24 stores the arrival time of the trigger pulse in the memory 25. In addition, the detecting unit 24 detects M-sequence initial condition data and stores the detected M-sequence initial condition data in the memory 25.

In the above description, the M-sequence initial conditions are included in the infrared-ray signal. However, a phase-modulated M-sequence ultrasonic model waveform generated based on predetermined M-sequence initial conditions may be stored in the memory 25 in advance. In this way, when an infrared trigger signal arrives at the receiving apparatus 20, the propagation time calculating unit 26 reads this M-sequence ultrasonic model waveform.

When the propagation time calculating unit 26 reads data representing the arrival of the trigger pulse from the memory 25, the propagation time calculating unit 26 generates an M-sequence model waveform from the stored M-sequence initial data. In addition, as with the case with the digital pen 10, the propagation time calculating unit 26 modulates the phase of the generated ultrasonic model waveform, to generate a phase-modulated ultrasonic M-sequence model waveform having a waveform identical to that of the ultrasonic wave driving signal on the transmitting side.

The propagation time calculating unit 26 executes correlation processing between this phase-modulated ultrasonic M-sequence model waveform and the phase-modulated ultrasonic received waveform stored in the memory 25. When the propagation time calculating unit 26 detects the first correlation value peak, the propagation time calculating unit 26 calculates the elapsed time from a time at which the trigger pulse arrives at the receiving apparatus 20 to a time at which this correlation value peak is detected (namely, the time required for the ultrasonic wave signal to propagate from the digital pen 10 to the receiving apparatus 20).

The propagation time calculating unit 26 sets the trigger detection time stored in the memory 25 to a sampling start time (t), reads the phase-modulated M-sequence ultrasonic data from the memory 25, and calculates a correlation value C(t) at the sampling start time t based on expression (1) between the read data and the previously generated phase-modulated M-sequence ultrasonic model waveform.

$$C ( t ) = \frac{1}{N} {\sum }_{i = 0}^{N - 1} r ( i ) f ( i + t ) \qquad ( 1 )$$

In expression (1), integer i represents a sampling time variable, integer N represents a model waveform sampling number, r(i) represents a model waveform value at the sampling time i, and f(i+t) represents a received waveform value at a sampling time (i+t).

The propagation time calculating unit 26 searches the obtained correlation values for a peak value. If the propagation time calculating unit 26 cannot detect a peak value, the propagation time calculating unit 26 increments the sampling start time (t) by 1, which is a unit amount, and repeats searching for a peak value.

If the propagation time calculating unit 26 detects a correlation peak value, the propagation time calculating unit 26 reads the sampling time that corresponds to the variable t at the time of detection from the memory 25. Finally, the propagation time calculating unit 26 calculates the ultrasonic wave propagation time from the digital pen 10 to the receiving apparatus 20, based on the trigger detection time and the peak value detection time. Assuming that the sampling time when the infrared trigger pulse is received is 0 and the sampling period is DT, the ultrasonic wave propagation time is given by t×DT.

In accordance with the above method, drawing can be realized by using a digital pen, based on measurement results of the ultrasonic wave propagation time.

### Third Exemplary Embodiment

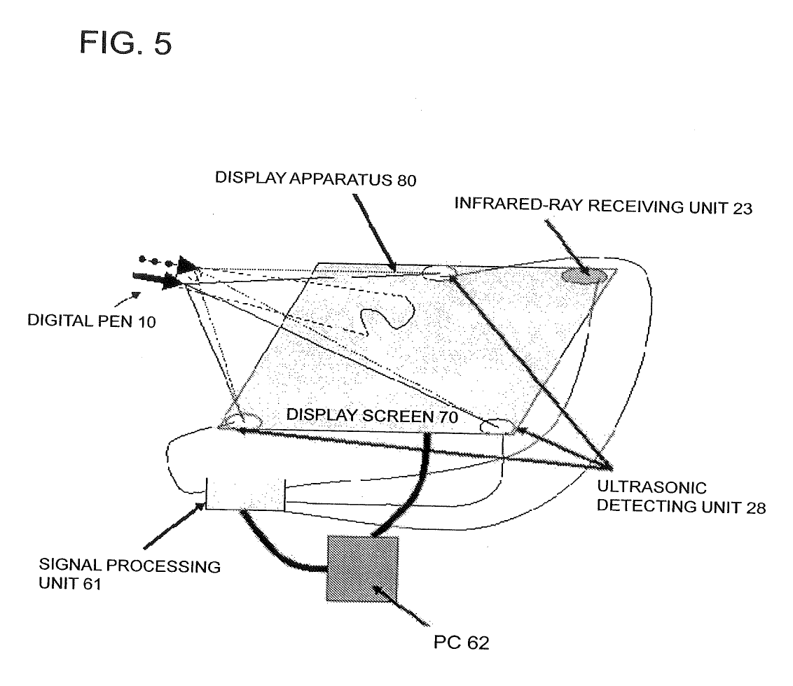

A digital pen system according to a third exemplary embodiment will be described with reference to the drawings. FIG. 5 schematically illustrates a configuration of a digital pen system according to the present exemplary embodiment.

In FIG. 5, the digital pen system includes a digital pen 10, an infrared-ray receiving unit 23, ultrasonic wave detecting units 28, a signal processing unit 61, a PC (Personal Computer) 62, and a display apparatus 80.

The display apparatus 80 may be a LCD (Liquid Crystal Display), a PDP (Plasma Display Panel), or an organic EL display, for example. At least three ultrasonic wave detecting units 28 are provided on a display screen of the display apparatus 80 or on a projection plane of a projector. The digital pen 10 includes an ultrasonic wave transmitting unit and an infrared-ray transmitting unit. The signal processing unit 61 receives an infrared-ray signal and an ultrasonic wave signal from the infrared-ray receiving unit 23 and the ultrasonic wave detecting unit 28, respectively, and transmits the signals to the PC 62. The PC 62 executes processing of the units (22 to 26) of the receiving apparatus 20 (FIG. 3).

The time when the infrared-ray receiving unit 23 receives an infrared-ray signal from the digital pen 10 is used as a reference time, and at least three ultrasonic wave detecting units 28 receive an ultrasonic wave signal from the digital pen 10. Based on the arrival time difference determined after correlation of M-sequence signals is calculated, the distance from the ultrasonic wave transmission source (a piezoelectric element or a magnetostrictive element, for example) included in the ultrasonic wave transmitting unit 14 of the digital pen 10 to the at least three ultrasonic wave detecting units 28 can be measured.

In this way, three-dimensional position data can be inputted, using the display screen 70 of the display apparatus 80 or the projection screen of the projector, on which at least three ultrasonic wave detecting units 28 are installed, as reference. A monitor-type PC, a PDA (Personal Digital Assistant), a mobile terminal, or the like may be used to realize similar functions.

The digital pen system enables input of characters or the like in space or input of the shape of a three-dimensional object by tracing the surface of the three-dimensional object. Thus, the digital pen system can be used for authentication by an arbitrary form of input, whether contact/non-contact. In addition, since an ultrasonic wave is used, no adverse effect is caused on a pacemaker and the like. Thus, by attaching the digital pens 10 to moving objects in medical practice and installing the ultrasonic wave receiving units 21 and the infrared-ray receiving units 23 in buildings, flow of medical supplies or various types of materials can be managed and whereabouts of patients, doctors, nurses, and the like can be checked.

### Fourth Exemplary Embodiment

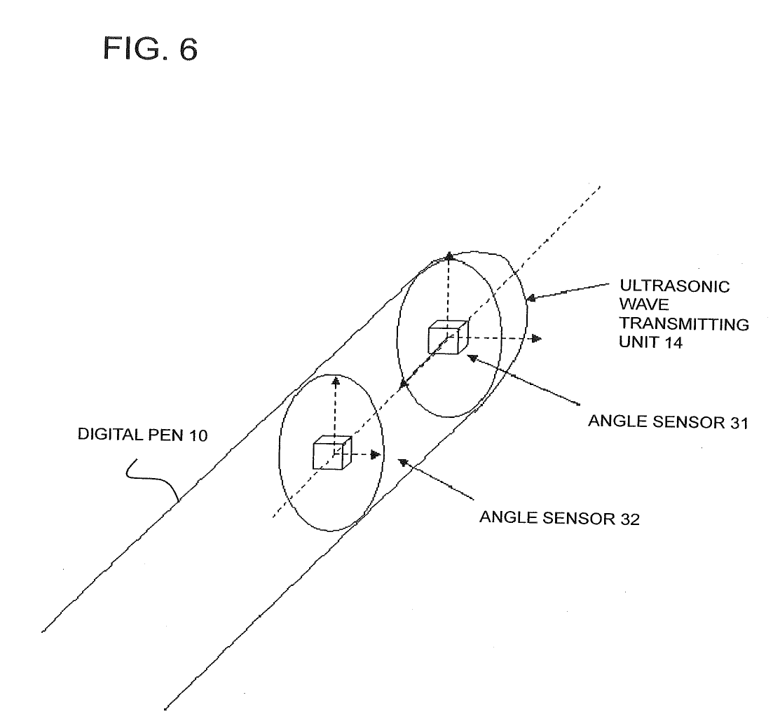

A digital pen system according to a fourth exemplary embodiment will be described with reference to the drawings. FIG. 6 schematically illustrates a configuration of a digital pen in a digital pen system according to the present exemplary embodiment.

In FIG. 6, the digital pen 10 includes sensors for measuring the direction (information about the angle) of the digital pen 10. With these sensors, the position of the ultrasonic wave transmission source of the digital pen 10 can be determined with respect to the display screen 70, on which at least three ultrasonic wave detecting units 28 are installed, as a reference. In addition, a character or the like can be inputted at the position on the display screen 70 indicated by the digital pen 10.

The digital pen 10 may have an arbitrary shape. However, to input characters, it is preferable that the digital pen 10 be pen-shaped. For example, if the digital pen has a cylindrical shape, even if a three-axis angle sensor is used, unless the rotation angle with respect to the display screen is determined, the intersection of the direction of the cylindrical axis and the display screen cannot be determined. The rotation angle can be measured by a one-axis angle sensor.

Thus, a three-axis angle sensor 31 is provided along the cylindrical axis, the center of a one-axis angle sensor 32 is aligned with the cylindrical axis, and the angle detection direction thereof is set to be, perpendicular to the cylindrical axis. In this way, the rotation angle of the cylindrical shape can be corrected, and the direction in which the digital pen 10 points can be determined.

It is preferable that the three-axis angle sensor 31 be provided at the center of the ultrasonic wave transmitting unit 14. For example, the angle sensor 32 for angle correction can be provided along the cylindrical axis. These items of angle information may be superimposed on an infrared-ray signal immediately before an ultrasonic wave is emitted, and the superimposed signal may be transmitted. Alternatively, the angle information may be transmitted as an infrared-ray signal a certain period of time after an ultrasonic wave is emitted. Alternatively, the angle information may be transmitted via another wireless apparatus. Alternatively, the angle information may be transmitted via wires.

As described above, if the spatial absolute position of the ultrasonic wave transmitting unit 14 of the digital pen 10 is determined with respect to the display screen on which at least three ultrasonic wave detecting units 28 are installed, based on the angle information about the digital pen 10, the intersection of the display screen and the cylindrical axis of the digital pen 10 can be determined. Thus, a digital pen system in three-dimensional space can be established.

The installation place of the infrared-ray receiving unit 23 is not limited to the display screen. The infrared-ray receiving unit 23 can be installed at any place where the infrared-ray receiving unit 23 can receive infrared rays. If the display apparatus 80 is a PDP, infrared-ray radiation from the screen is particularly large. Thus, it is preferable that the infrared-ray receiving unit 23 be installed at a place away from the screen.

In addition, if a laser pointer is installed along the axis of the digital pen 10, drawing can be carried out at the position indicated by the laser pointer. As a result, input operability is improved.

In addition, since drawing is carried out at the intersection of the plane formed by at least three ultrasonic wave detecting units 28 and the axis of the digital pen 10, accurate drawing can be carried out even on a curved surface whose curvature is known in advance, the at least three ultrasonic wave detecting units 28 being provided on the curved surface. Thus, drawing can be carried out on a pseudo-cylindrical surface in a large school classroom. In addition, by increasing the number of the ultrasonic wave detecting units 28, 360-degree drawing can be carried out in a cylindrical meeting room.

If a front projector is used and a person enters the projection space for drawing, a shadow is caused, making it difficult to perform drawing. However, with this system configuration, such problem is not caused. In addition, viewing by those other than the person performing drawing is not blocked. Therefore, for users of the digital pen system, operability is improved.

If the distance between the digital pen 10 and the display screen 70 is increased, a small change of the angle of the digital pen 10 greatly moves the intersection, making it difficult to perform drawing. In this case, the intersection migration rate may be changed, depending on the distance between the digital pen 10 and the display screen 70. In this way, operability in drawing is improved.

In addition, to prevent an impact from finger shaking caused when the digital pen 10 is moved in space, it is preferable that an inertial actuator similar to a gyroscope be inserted into the digital pen or that a haptic force actuator which adds reaction force in the direction of movement or gives an illusion that reaction force is added into the digital pen 10. In this way, the size of the digital pen 10 can be maintained to be small, and the operability can be improved.

While the present invention has thus been described with reference to the above exemplary embodiments, the present invention is not limited thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept.

1. A digital pen system, comprising:
a rod-shaped digital pen that periodically transmits a signal including information about a direction of the digital pen; and
a receiving apparatus that detects a position and the direction of the digital pen in three-dimensional space based on the signal, calculates an intersection of an extension line of the digital pen in a longitudinal direction thereof and a display screen of a display apparatus in a case that the digital pen and the display screen are apart from each other, and enables the display apparatus to perform a pen-based input at the intersection on the display screen.

2. The digital pen system according to claim 1, wherein the digital pen comprises:
an electromagnetic wave transmitting unit that transmits an electromagnetic wave signal representing a transmission timing;
an ultrasonic wave driving unit that modulates an ultrasonic wave based on a pseudorandom signal having high autocorrelation simultaneously with transmission of the electromagnetic wave signal to generate an ultrasonic wave driving signal; and
an ultrasonic wave transmitting unit that is driven by the ultrasonic wave driving signal and transmits an ultrasonic wave signal having a frequency higher than a fundamental frequency of the ultrasonic wave driving signal.

3. The digital pen system according to claim 2, wherein the receiving apparatus comprises:
an electromagnetic wave receiving unit that detects the electromagnetic wave signal;
an ultrasonic wave receiving unit that comprises at least three ultrasonic wave detecting units that are not arranged on a single line and receives the ultrasonic wave signal via the at least three ultrasonic wave detecting units; and
a propagation time calculating unit that uses a waveform identical to that of the ultrasonic wave driving signal as a model waveform, calculates correlation values between the received ultrasonic wave signal and the model waveform, detects a main peak value of the calculated correlation values, and calculates an ultrasonic wave propagation time based on a time when the electromagnetic wave signal is detected and a time when the main peak value is detected.

4. The digital pen system according to claim 1, wherein the digital pen further comprises an angle sensor that determines at least four-axis directions, and the direction of the digital pen is determined based on the angle sensor.

5. The digital pen system according to claim 4, wherein the angle sensor comprises an acceleration sensor.

6. The digital pen system according to claim 5, wherein the angle sensor comprises a three-axis acceleration sensor and a two-axis acceleration sensor.

7. The digital pen system according to claim 4, wherein the angle sensor comprises a gyro sensor.

8. The digital pen system according to claim 2, wherein the ultrasonic wave transmitting unit comprises a piezoelectric element or a magnetostrictive element.

9. The digital pen system according to claim 2, wherein the ultrasonic wave transmitting unit includes a transmission surface that is substantially spherical.

10. The digital pen system according to claim 3, wherein the ultrasonic wave receiving unit comprises a piezoelectric element, a magnetostrictive element, or a microphone.

11. The digital pen system according to claim 3, wherein at least two of the at least three ultrasonic wave detecting units are fixedly positioned.

12. The digital pen system according to claim 3, wherein the at least three ultrasonic wave detecting units are provided on the display screen or on an extension surface thereof.

13. The digital pen system according to claim 1, wherein the digital pen comprises a laser pointer that indicates the intersection.

14. The digital pen system according to claim 13, wherein generation timings of the laser pointer and an ultrasonic wave signal and/or an electromagnetic wave signal are coordinated, and a track of the laser pointer is displayed on the display screen.

15. The digital pen system according to claim 2, wherein the pseudorandom signal comprises an M-sequence signal.

16. A pen-based input method, comprising:
by a digital pen, periodically transmitting a signal including information about a direction of the digital pen; and
by a receiving apparatus, detecting a position and the direction of the digital pen in a three-dimensional space based on the signal, calculating an intersection of an extension line of the digital pen in a longitudinal direction thereof and a display screen of a display apparatus in a case that the digital pen and the display screen are apart from each other, and enabling the display apparatus to a perform pen-based input at the intersection on the display screen.

17. The pen-based input method according to claim 16, further comprising:
by the digital pen, transmitting an electromagnetic wave signal representing a transmission timing;
modulating an ultrasonic wave based on a pseudorandom signal having high autocorrelation simultaneously with transmission of the electromagnetic wave signal to generate an ultrasonic wave driving signal; and
being driven by the ultrasonic wave driving signal and transmitting an ultrasonic wave signal having a frequency higher than a fundamental frequency of the ultrasonic wave driving signal.

18. The pen-based input method according to claim 17, further comprising:
by the receiving apparatus, detecting the electromagnetic wave signal;
receiving the ultrasonic wave signal via at least three ultrasonic wave detecting units that are not arranged on a single line; and
using a waveform identical to that of the ultrasonic wave driving signal as a model waveform, calculating correlation values between the received ultrasonic wave signal and the model waveform, detecting a main peak value of the calculated correlation values, and calculating an ultrasonic wave propagation time based on a time when the electromagnetic wave signal is detected and a time when the main peak value is detected.

19-20. (canceled)

21. The pen-based input method according to claim 16, further comprising:
determining at least four-axis directions to determine the direction of the digital pen.

22. A digital pen system, comprising:
a rod-shaped digital pen that periodically transmits a signal including information about a direction of the digital pen;
a receiving apparatus that detects a position and the direction of the digital pen in three-dimensional space based on the signal, calculates an intersection of an extension line of the digital pen in a longitudinal direction thereof and a display screen of a display apparatus in a case that the digital pen and the display screen are apart from each other, and enables the display apparatus to perform a pen-based input at the intersection on the display screen,
wherein the digital pen comprises:
an electromagnetic wave transmitting unit that transmits an electromagnetic wave signal representing a transmission timing;
an ultrasonic wave driving unit that modulates an ultrasonic wave based on a pseudorandom signal having high autocorrelation simultaneously with transmission of the electromagnetic wave signal to generate an ultrasonic wave driving signal; and
an ultrasonic wave transmitting unit that is driven by the ultrasonic wave driving signal and transmits an ultrasonic wave signal having a frequency higher than a fundamental frequency of the ultrasonic wave driving signal; and
an angle sensor that determines at least four-axis directions, and the direction of the digital pen is determined based on the angle sensor,
wherein the digital pen comprises a laser pointer that indicates the intersection, and
wherein generation timings of the laser pointer, the ultrasonic wave signal, and the electromagnetic wave signal are coordinated, and a track of the laser pointer is displayed on the display screen.
